(19) United States
(12) Patent Application Publication
(10) Pub. No.: US 2014/0216246 A1
(43) Pub. Date: Aug. 7, 2014

(54) PISTON

(71) Applicant: Franz Laimboeck, Goleta, CA (US)

(72) Inventor: Franz Laimboeck, Goleta, CA (US)

(73) Assignee: MAHLE KOENIG KOMMANDITGESELLSCHAFT GMBH & CO. KG, RANKWEIL (AT)

(21) Appl. No.: 14/124,899

(22) PCT Filed: Jun. 6, 2012
(86) PCT No.: PCT/AT2012/000161

§ 371 Date: Mar. 6, 2014

(30) Foreign Application Priority Data
Jun. 7, 2011 (AT) A843/2011

(51) Int. Cl. F16J 1/00

(52) U.S. Cl. CPC F16J 1/005
USPC 92/208

(57) ABSTRACT

A piston has a piston crown, a piston pin support that extends from the piston crown, and a skirt wall that is connected to the piston crown. The skirt wall has two tubular pieces which are concentrically arranged relative to each other and each of which is connected to the piston crown in the circumferential region of the piston crown. A hollow space cavity is formed between the tubular pieces and a coolant is disposed in the cavity.

The invention relates to a piston in accordance with the preamble of patent claim 1.

It is the aim of the invention to ensure high thermal stability in pistons of this kind. Durability should furthermore be as great as possible. Pistons of this kind should have a low weight and be suitable for production in a simple manner from a small number of components. According to the invention, this is achieved in the case of a piston of the type stated at the outset having the features presented in the characterizing clause of claim 1.

By means of the concentrically arranged tubular pieces arranged in the circumferential region of the piston head and secured on the latter, a piston of stable construction with a deformation-resistant skirt wall is provided which has the required endurance in operation. Moreover, the piston can be produced from easily manufactured components, in particular tubular pieces or integral piston head/piston pin support components that can be produced by casting, thus allowing a piston to be manufactured quickly.

It is advantageous for the strength of the piston if the tubular piece situated on the outside rests against an outward-oriented offset of the piston head or touches the piston head, and/or the tubular piece situated on the inside rests against an inward-oriented offset of the piston head or touches the piston head. This means that it is also a simple matter to produce a welded joint between the tubular pieces and the piston head.

Welding that circumferential end edge of the tubular piece situated on the inside which is remote from the piston head to the tubular piece situated on the outside contributes to stable connection of the two tubular pieces. Welded joints of this kind can be produced quickly and are durable. Fitting concentric tubular pieces gives the skirt wall a markedly high rigidity.

In order to improve the connection of the two tubular pieces and to increase the strength properties of the skirt wall, provision is made for outward-projecting protrusions, via which the two tubular pieces can be connected to one another, preferably by spot welding, to be formed in the tubular piece situated on the inside.

This measure in no way conflicts with the advantage that a cavity in which coolant is arranged can be formed between the tubular pieces. In addition to high strength, the piston according to the invention thus also has the possibility for providing coolant within the skirt wall.

Provision is furthermore made for a cover plate to be mounted on that surface of the piston head which is adjacent to the combustion chamber, said cover plate being at a distance from said surface and forming a hollow chamber with said surface. The cavity and the hollow chamber are connected by ducts extending through the rim of the piston head, and a coolant which is liquid at the piston operating temperature and solid at room temperature is advantageously contained in the cavity and/or the hollow chamber. Approximately one third of the available volume is filled with coolant. Thus, in addition to high endurance of the piston or of the skirt wall and of the piston head, there are good cooling possibilities for the piston in operation.

It is advantageous if the two tubular pieces are arranged concentrically to form a cavity extending at least over partial regions of the height of the skirt wall or of the inner tubular piece. It is expedient if the cavity extends over the entire height of the tubular piece situated on the inside, except where provision is made for that end region of the inner tubular piece which is remote from the piston head to be widened and to rest against the inner surface of the outer tubular piece by means of the widened region. Joining to the outer tubular piece can preferably be accomplished by roller welding. This narrowed or circumferentially reduced end region increases the stability of the skirt wall through appropriate support of the tubular piece situated on the outside.

It is advantageous in terms of design if the ducts open into the region of the piston head which is situated between the two concentrically arranged tubular pieces. In order to provide the necessary space, it is expedient if the inner tubular piece has an inward-sloping or circumferentially reduced end region in the outlet region of the ducts.

In terms of strength for the formation of the hollow chamber, it is advantageous if spacers for supporting the cover plate project upward from the surface of the piston head within the hollow chamber, wherein, if appropriate, the cover plate is connected to said spacers by spot welding.

For stable and quick production of the piston, the cover plate and/or the tubular pieces can be welded to the piston head and/or can be connected to the latter by forming an interference fit and/or by means of beading. This gives the piston the strength properties required for extensive operation.

In order to minimize the friction losses of the piston during operation, at least the outer tubular piece, preferably both tubular pieces, can form a continuous skirt wall without apertures, which is of closed and continuous design in the region of the piston pin as well. Provision can also be made for the regions of the skirt wall which are close to or opposite to the end regions of the piston pin to have apertures, which apertures are closed off by closing parts which, if appropriate, continue the outer surface of the skirt wall or follow the surface profile of the tubular piece situated on the outside.

Maximum stability and optimum strength properties are achieved if the piston head and the piston pin support are produced from cast material, preferably spheroidal graphite cast iron, and/or if the tubular pieces are formed by steel or aluminum or light metal alloys, if appropriate fiber reinforced light metal alloys, and/or if the cover plate is produced from a steel plate, advantageously from a steel plate with a convex curvature toward the combustion chamber. A combustion-promoting and/or corrosion-inhibiting and/or insulating coating of the cover plate is possible. The cover plate can also be formed entirely by combustion-promoting and/or corrosion-inhibiting and/or insulating material. It is also possible for the piston to be forged or produced from cast aluminum.

Simple production is achieved if the piston head and the piston pin support are designed as a one-piece casting. The piston pin can be welded into the piston pin support. The piston pin is expediently produced from a steel tube.

A piston rod can be mounted pivotably on the piston pin by means of a bearing. It is advantageous here if the bearing surrounding the piston pin and the lug of the piston pin are designed to be dividable or are constructed from parts which can be assembled. It is also possible for the piston pin support to be designed to be assembled from several parts.

For the use of the piston according to the invention in a two-stroke engine, it is advantageous if the skirt wall surface of the piston, preferably the outer tubular piece, has two mutually opposite extensions or continuations, each extending over a predetermined circumferential region. In this way, the corresponding openings in the cylinder can be covered or opened in the required manner. Specifically in this case, it is advantageous if the inner tubular piece extends as far as that end region of the skirt wall or of the outer tubular piece which is situated between the extensions.

At least one groove for receiving a piston ring can be formed along the circumference of the piston head.

The invention is explained in greater detail below by way of example by means of the drawing.

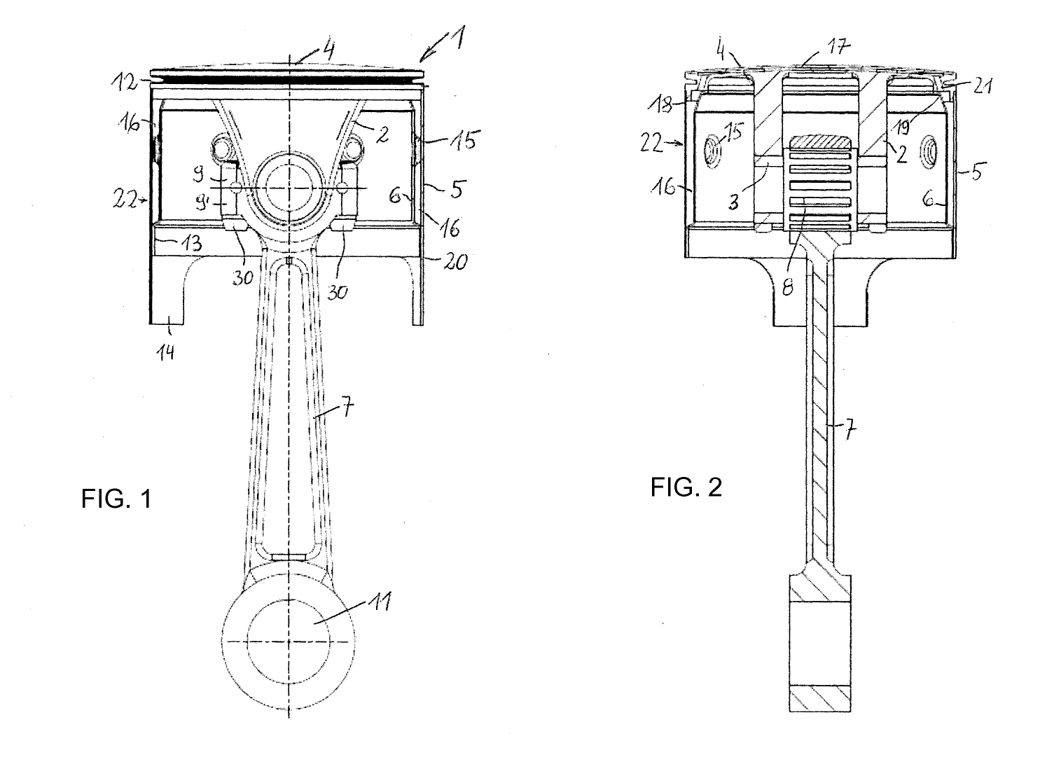

FIG. 1 shows a piston according to the invention having a piston rod in a schematic section. FIG. 1a shows an enlarged view of said piston.

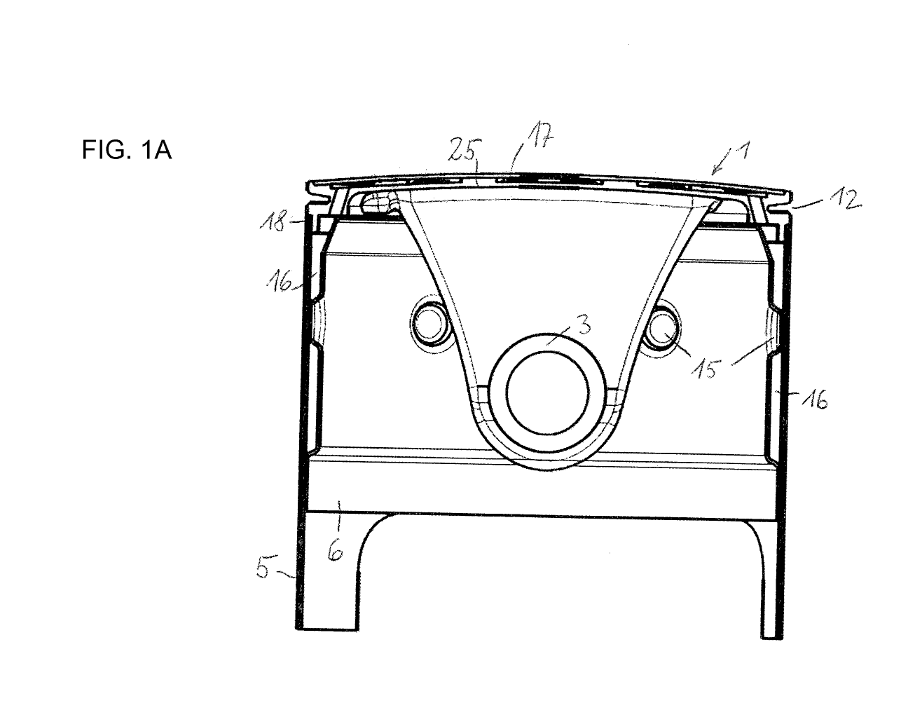

FIG. 2 shows a piston according to the invention in a section rotated through 90° relative to the view in FIG. 1.

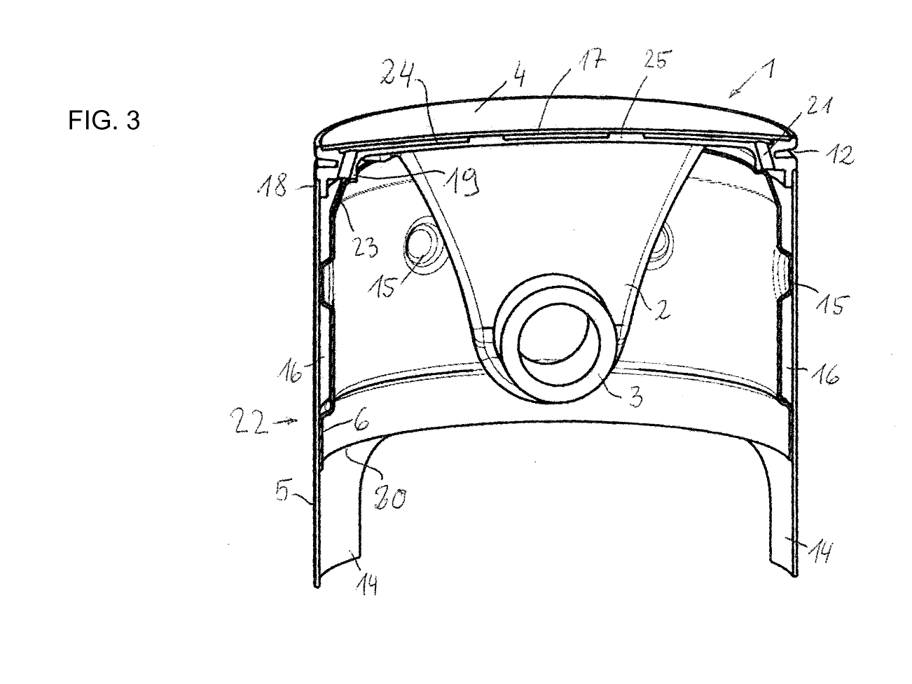

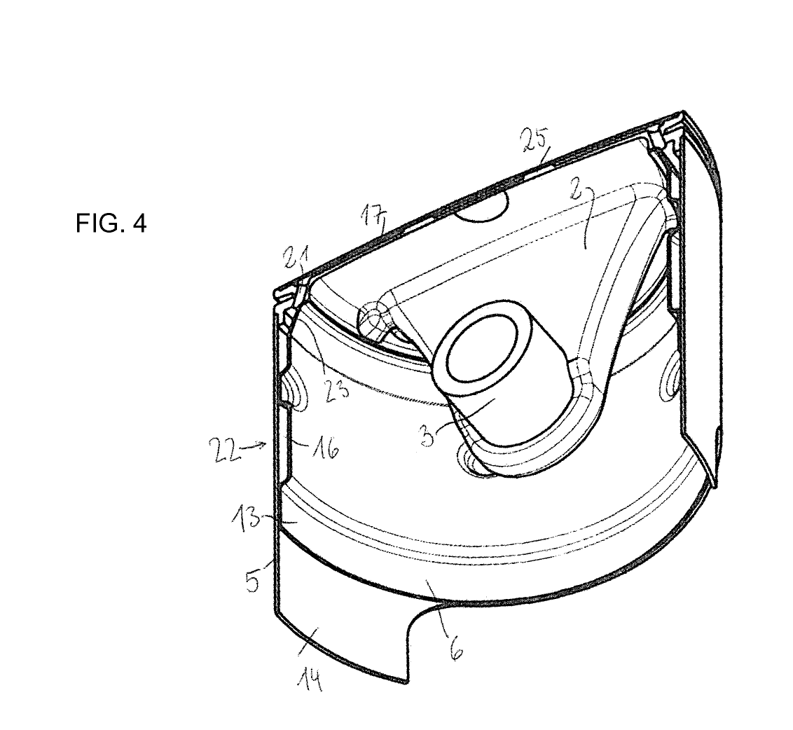

FIG. 3 and FIG. 4 show an oblique view of a sectioned piston.

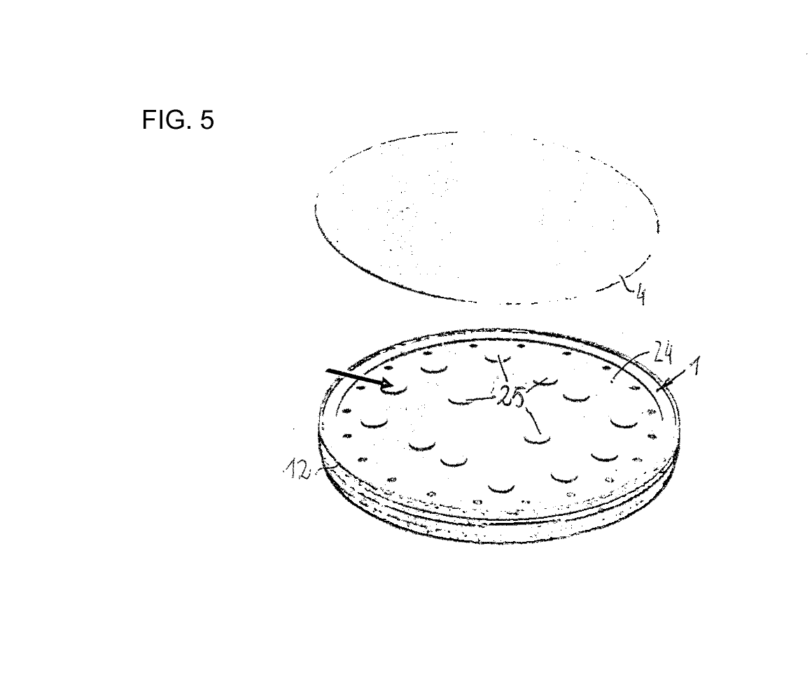

FIG. 5 shows a piston head and a cover plate that can be mounted thereon.

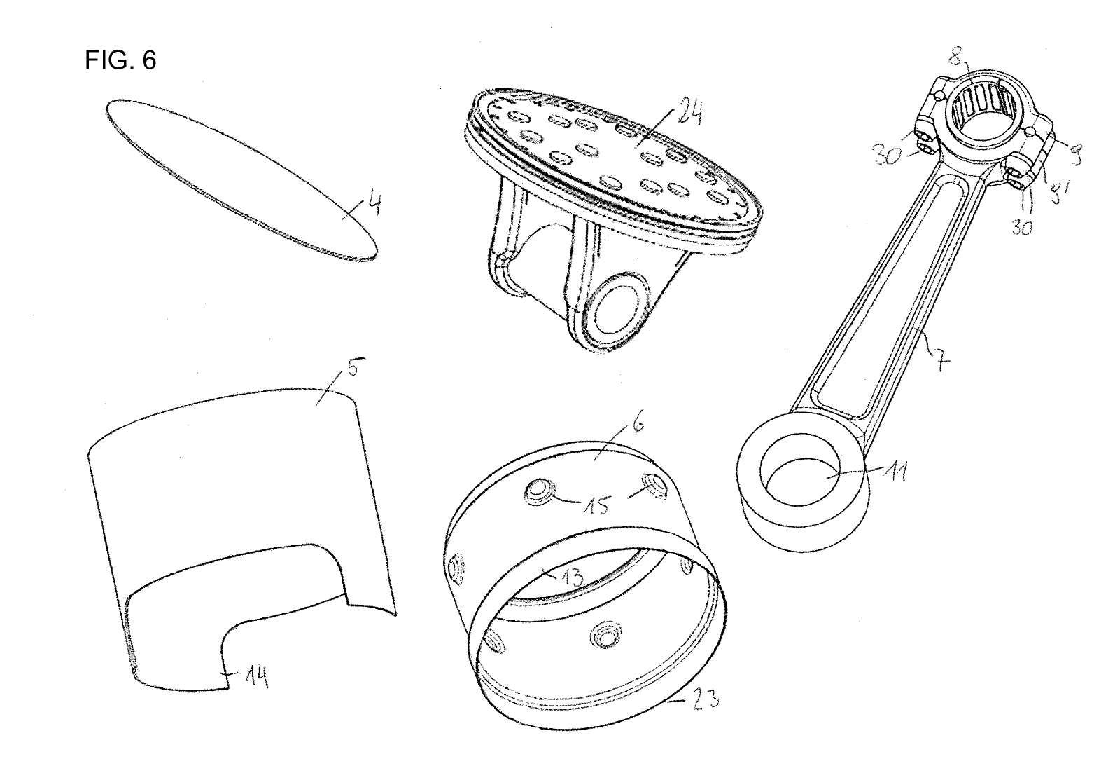

FIG. 6 shows a view of the significant components required to produce a piston according to the invention, namely a piston head with a piston pin support, a cover plate, a piston pin, a piston rod with a bearing and two tubular pieces to form the skirt wall.

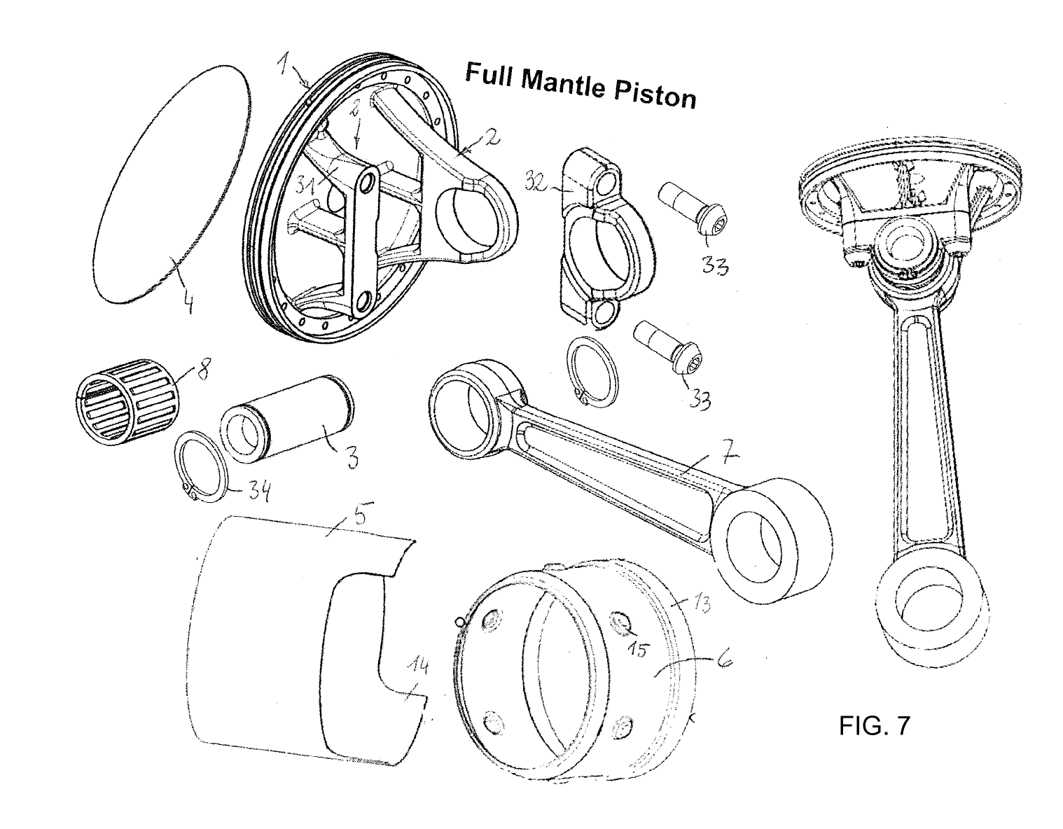

FIG. 7 shows an alternative embodiment of a piston or of its individual parts.

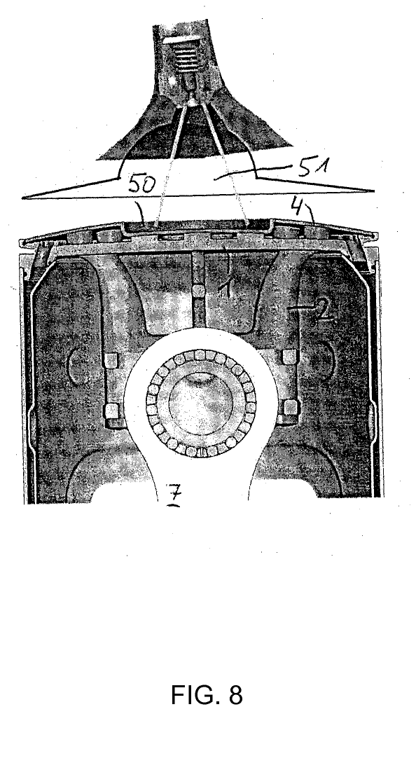

FIG. 8 shows an embodiment of a piston in section.

FIG. 1 shows, in a schematic section, a piston according to the invention, which is provided with a piston rod 7, which has an aperture 11 for the crankshaft. The piston comprises a piston head 1, which is covered on the combustion chamber side by a cover plate 4. At least one encircling groove 12 for receiving a piston ring is formed in the piston head 1. A tubular piece 5 situated on the outside and furthermore a tubular piece 6 situated on the inside are secured or attached to the piston head 1 by welding and/or by the formation of an interference fit and/or the formation of beading. The two tubular pieces 5, 6 rest substantially concentrically one upon the other. Slight deviations from a concentric arrangement can be implemented for reasons of stability and strength. An eccentric arrangement of the tubular piece situated on the inside by 0.5 mm, for example, is quite possible. Normally, circular tubular pieces or elliptically shaped tubular pieces having a slight eccentricity are used. The tubular piece 5 situated on the outside forms the outer surface of the skirt wall 22 produced by the two tubular pieces 5 and 6. An annular cavity 16 is formed between the tubular piece 6 situated on the inside, which forms the inner wall of the skirt wall 22, and the tubular piece 5 situated on the outside, since these two tubes are arranged concentrically at a predetermined spacing from one another. Protrusions 15 can be formed in the inner tubular piece 6, which protrusions rest against the inner wall surface of the tubular piece 5 situated on the outside and can be connected to the tubular piece 5 situated on the outside by welds, in particular by spot welding or resistance pressure welding.

That end region of the tubular piece 5 situated on the inside which is remote from the combustion chamber has a widened wall region 13, which rests against the inner surface of the tubular piece 5 situated on the outside. The tubular piece 6 situated on the inside can be welded to the tubular piece 5 situated on the outside along that end edge 20 of the tubular piece 6 situated on the inside which is remote from the combustion chamber.

In the end region remote from the combustion chamber, the tubular piece 5 situated on the outside has extensions 14, which, if appropriate, can also be implemented in the same form and position on the tubular piece 6 situated on the inside. These extensions 14 serve to close or expose channels and openings in the wall of the cylinder in which the piston runs.

A piston pin support 2 is formed on the piston head 1. The piston head 1 and the piston pin support 2 are advantageously produced integrally. A piston pin 3 is inserted, in particular welded, into the piston pin support 2. The piston rod 7 has a bearing 8 which surrounds the piston pin 3. This bearing 8 can be divided, allowing it to be laid around or mounted on a welded-in piston pin 3. Moreover, the parts 9, 9′ of the piston rod 7 which surround the bearing 8 are embodied in a manner which allows them to be divided, wherein the two parts 9 and 9′ can be connected to one another by means of screws 30.

FIG. 1a shows an enlarged central section through the piston shown in FIG. 1, in which the details can be seen more clearly.

FIG. 2 shows the piston according to the invention in accordance with FIG. 1 in a section perpendicular to the section shown in FIG. 1. The bearing 8 which surrounds the piston pin 3 can be seen. The cover plate 4 is at a distance from that surface 24 of the piston head 1 which is adjacent to the combustion chamber, thus creating a cavity 17 in the interspace between the cover plate 4 and the surface 24. This cavity 17 communicates via ducts 21 passing through the piston head 1 with the cavity 16 between the tubular piece 5 situated on the outside and the tubular piece 6 situated on the inside. It is envisaged that the cavity 16 and the hollow chamber 17 will be connected by ducts 21 extending through the rim of the piston head 1 and that a coolant which is liquid at the piston operating temperature and solid at room temperature will be contained in the cavity 16 and the hollow chamber 17. A multiplicity of ducts, e.g. 20 ducts, can be formed along the circumference of the piston head 1. During operation, the coolant is moved backward and forward between the cavity 16 and the hollow chamber 17, depending on the movement of the piston.

FIG. 3 shows a section through a piston according to the invention in accordance with figure la in perspective. The tubular piece 5 situated on the outside rests against an outward-oriented offset 18 of the piston head 1. In this region, the tubular piece 5 situated on the outside can be welded to the piston head 1. The tubular piece 6 situated on the inside can rest against an inward-oriented offset 19 of the piston head 1 or, alternatively, can abut the inner surface of the piston head 1 and is welded to the piston head 1 at the point of abutment.

That circumferential end edge 20 of the tubular piece 6 situated on the inside which is remote from the piston head is welded to the tubular piece 5 situated on the outside. It can furthermore be seen from FIG. 3 that outward-projecting protrusions 15 are formed in the tubular piece 6 situated on the inside, by means of which protrusions the two tubular pieces 5, 6 rest against one another. The shape of the protrusions 15 and/or the number thereof is a matter of arbitrary choice. It is advantageous if these protrusions 15 extend approximately half way up the cavity 16 situated between the tubular pieces 5 and 6. The protrusions 15 are arranged at uniform intervals around the circumference. The protrusions 15 can be welded to the tubular piece 5 situated on the outside.

Spacers 25 for supporting the cover plate 4 project upward from the surface 24 of the piston head 1 within the hollow chamber 17, wherein, if appropriate, the cover plate 4 is connected to said spacers 25 by spot welding.

The ducts 21 open in the region of the piston head 1 into the cavity 16 which is situated between the two concentrically arranged tubular pieces 5, 6. It is advantageous structurally if the inner tubular piece 6 has a narrowed or circumferentially reduced end region 23 in the outlet region of the ducts 21.

FIG. 4 shows another sectioned view of a piston in accordance with FIG. 1a in perspective, the piston having been sectioned in the same plane as the piston shown in FIG. 3. Here too, it can be seen that the two tubular pieces 5, 6 are arranged concentrically to form a cavity 16 extending at least over partial regions of the height of the skirt wall 22 or of the inner tubular piece 6 and that a cover plate 4 is mounted on the surface 24 of the piston head 1 which is adjacent to the combustion chamber, said cover plate being at a distance from said surface 24 and forming a hollow chamber 17 with said surface 24.

Coolants that are known per se are used as coolants. Use is made of coolants which are liquid at the piston operating temperature and solid at room temperature. Approximately one third of the volume of the hollow chamber 17 and of the cavity 16 are filled with coolant. FIG. 4 furthermore shows that that end region 13 of the inner tubular piece 6 which is remote from the piston head is widened and rests against the inner surface of the outer tubular piece 5.

FIG. 5 shows, in a detail view, a cover plate 4, which is mounted on that surface 24 of the piston head 1 which is adjacent to the combustion chamber and is preferably welded on there. The spacers 25 which project upward from the surface 24 of the piston head 1 support the cover plate 4, thus allowing the hollow chamber 17 to be created between the cover plate 4 and the surface 24 and enabling it to be maintained during operation, even at high pressure.

FIG. 6 shows the essential components required to produce a piston according to the invention with a connecting rod.

FIG. 7 shows the individual parts of an alternative embodiment of a piston according to the invention, in which the piston pin support 2 is modified. Of the two supports of the piston pin support, one support comprises a base part 31, which is connected to the piston head 1 or formed integrally therewith. A bearing part 32, into which a piston pin 3 is inserted rotatably or can be welded in a fixed manner, can be connected to this base part 31, using screws 33 to screw it on, for example. The piston pin 3 could also be fixed by means of circlips 34. With this way of mounting the piston pin 3, mounting apertures in the skirt wall 22 are not required.

It is advantageous in terms of strength if the cover plate 4 and/or the tubular pieces 5, 6 are welded to the piston head 1. In principle, it is also possible to connect these components by means of an interference fit and/or by means of beading if the demands are lower.

For operation, it is advantageous if at least the outer tubular piece 5, preferably both tubular pieces 5, 6, form a continuous skirt wall 22 without apertures, which is of closed and continuous design in the region of the piston pin 3 as well. If the regions of the skirt wall 22 which are close to or opposite to the end regions of the piston pin 3 have apertures for insertion of the piston pin 3, these apertures can be closed off by closing parts which, if appropriate, continue the surface of the skirt wall 22 or follow the surface profile of the skirt wall 22. An unwanted transfer of gas into the crank case is thereby avoided.

Particularly high strength values and endurance levels are achieved if the piston head 1 and the piston pin support 2 are produced from cast material, preferably spheroidal graphite cast iron, or by forging. Fiber reinforced aluminum, magnesium or other light metal alloys may also be considered as materials. The tubular pieces 5, 6 are formed by steel and the cover plate 4 can be produced from a steel plate, advantageously from a steel plate with a convex outward curvature. According to FIGS. 3 and 4, the piston head 1 and the piston pin support 2 are designed as a one-piece casting; the piston pin 3 is welded into the piston pin support 2.

FIG. 6 shows the bearing 8, by means of which the piston rod 7 is mounted pivotably on the piston pin 3. It is advantageous here if both the bearing 8 surrounding the piston pin 3 and the lug of the piston rod 7 are designed to be dividable or are constructed from parts 9, 9′ which can be assembled using screws 30.

It is particularly advantageous according to the invention to produce a solid-skirt piston which, without openings in the skirt wall 22, has optimum sliding properties. The regions of the skirt wall 22 which are close to the ends of the piston pin 3 can be closed or are covered by the outer tubular piece 5 in the case of a piston pin 3 which is not welded into the piston pin support 2. The skirt wall 22 is stable and rigid by virtue of the two concentric tubes 5, 6 welded to one another. The use of spheroidal graphite iron and steel material, in particular, ensures that maximum thermal stability is achieved. The bending stiffness of the skirt wall 22 due to the two concentric and interconnected tubes 5, 6 results in high endurance. The possibility of making the inserted tubular pieces 5, 6 thin-walled results in a low weight for the piston. The thickness of the tubes 5, 6 and of the cover plate 4 is less than 1 mm. In the case of tubes 5, 6 made of light metal, the thickness can be up to 2 mm without increasing the weight compared with steel tubes.

The invention also relates to an engine having at least one cylinder in which a piston of the type according to the invention is arranged.

Sodium acetate trihydrate in the form of a fine granular powder can advantageously be used as a coolant. Approximately one third of the hollow chamber 17 and the cavity 16 in the piston jacket or in the skirt wall 22 can be filled therewith. To introduce the coolant, an inlet opening can be formed in the skirt wall 22 and/or in the piston head 1 and can be closed with a screw plug, e.g. a grub screw. The jet of fuel injected is indicated by 51 in FIG. 8.

As FIG. 8 shows, a centrally situated depression 50 can be formed in the cover plate 4. This depression 50 of cylindrical circumferential shape prevents injected fuel from being reflected to the piston walls by this region of the cover plate 4. The cover plate 4 in which this depression 50 is formed can be of convex design in the outer circumferential regions thereof. The bottom surface of the recess 50 can also have a slight convexity.

It is noteworthy that, in the case of the subject matter of the invention, the concentric arrangement of tubular pieces 5, 6 at a predetermined spacing enables a strong and nevertheless flexible skirt wall 22 to be formed, especially in view of the fact that the skirt wall 22 must absorb considerable thermal expansion and bending moments. For this reason, it is expedient to weld the two tubular pieces 5, 6 forming the skirt wall 22 securely to the piston head 4. This results in a good connection between the elements consisting of different materials, namely the piston head 4, on the one hand, and the two tubular pieces 5, 6, on the other. The two tubular pieces 5, 6 form a high-strength skirt wall 22 enclosing the cavity 16.

It is possible to construct the spacers 25 provided to support the cover plate in the form of solid cylinders or in the form of annular cylinders. With the formation of annular cylinders, the heat transfer from the cover plate 4 to the piston head 1 is reduced.

1-26. (canceled)

27. A piston, comprising:
a piston head;
a piston pin support projecting from said piston head; and
a skirt wall connected to said piston head, said skirt wall including two tubular pieces arranged concentrically with one another and each connected to said piston head in a periphery of said piston head, said tubular pieces being disposed to form a cavity therebetween; and
a coolant disposed in said cavity between said mutually concentric tubular pieces.

28. The piston according to claim 27, wherein said tubular pieces include an outer tubular piece and an inner tubular piece, and one or both of the following is true: said outer tubular piece rests against an outward-oriented offset of said piston head or touches said piston head and said inner tubular piece rests against an inward-oriented offset of said piston head or touches said piston head.

29. The piston according to claim 28, wherein a circumferential end edge of said inner tubular piece remote from said piston head is welded to said outer tubular piece.

30. The piston according to claim 27, which comprises outwardly projecting protrusions formed on said inner tubular piece for supporting said two tubular pieces on one another and/or connecting said two tubular pieces to one another.

31. The piston according to claim 27, which comprises a cover plate mounted to form a crown of said piston head proximal to a combustion chamber, said cover plate being disposed at a distance from an upper surface of said piston head and forming a hollow chamber with said surface.

32. The piston according to claim 31, wherein said cavity and said hollow chamber are fluidically connected via ducts extending through a rim of said piston head, wherein said coolant is in liquid phase at a piston operating temperature and in solid phase at room temperature and said coolant is contained in one or both of said cavity or said hollow chamber.

33. The piston according to claim 32, wherein said tubular pieces include an inner tubular piece and an outer tubular piece, and an end region of said inner tubular piece which is distal from said piston head is widened and rests against an inner surface of said outer tubular piece.

34. The piston according to claim 32, wherein said ducts open into a region of said piston head between said two concentrically arranged tubular pieces, and wherein said inner tubular piece has an inward-sloping or circumferentially reduced end region in an outlet region of the ducts.

35. The piston according to claim 27, wherein said tubular pieces include an inner tubular piece and an outer tubular piece, and at least said outer tubular piece, or both said tubular pieces, forms a continuous skirt wall without apertures, which is closed and continuous in a region of a piston pin.

36. The piston according to claim 27, wherein said tubular pieces include an inner tubular piece and an outer tubular piece, and regions of said skirt wall which are close to or opposite end regions of a piston pin are formed with apertures, and said apertures are closed off by closing parts which, if appropriate, continue an outer surface of the skirt wall or follow a surface profile of said outer tubular piece.

37. The piston according to claim 27, wherein said piston head and said piston pin support are produced of cast material, or are forged and/or said tubular pieces are formed by steel or aluminum or light metal alloys and/or said cover plate is produced from a steel plate.

38. The piston according to claim 27, wherein said piston head and said piston pin support are integrally formed as a one-piece casting.

39. The piston according to claim 27, which comprises a piston pin welded into said piston pin support.

40. The piston according to claim 27, which comprises a piston rod pivotally mounted on said piston pin by way of a bearing.

41. The piston according to claim 40, wherein said bearing surrounding said piston pin and a lug of said piston pin are configured dividable or are constructed from parts that can be assembled, or wherein at least one support of said piston pin is configured to be dividable and has a base part connected to said piston head and a bearing part for said piston pin, and wherein said bearing part is connectible to said base part.

42. The piston according to claim 27, wherein said skirt wall surface of the piston has two mutually opposite extensions or continuations, each extending over a predetermined circumferential region, and said inner tubular piece extends as far as that end region of said skirt wall or of said outer tubular piece which is situated between the extensions.

43. The piston according to claim 27, wherein at least one groove for receiving a piston ring is formed along a circumference of said piston head.

44. The piston according to claim 27, wherein said piston head is formed with a depression.

45. The piston according to claim 31, wherein 25 to 45% of a volume of at least one or both of said cavity or said hollow chamber are filled with said coolant.

46. An engine, comprising at least one cylinder with a piston according to claim 27 disposed therein.
